(19) United States
(12) Patent Application Publication
(10) Pub. No.: US 2012/0168699 A1
(43) Pub. Date: Jul. 5, 2012

(54) DEVICE AND METHOD FOR FISH TAPE REEL SYSTEM

(76) Inventors: Yona RACHMINOV, Tel Aviv (IL); Michele PERETS, Tel Aviv (IL); Tomer HAYUN, Or Yehuda (IL)

(21) Appl. No.: 12/984,622

(22) Filed: Jan. 5, 2011

(51) Int. Cl. H02G 1/08

(52) U.S. Cl. 254/134.3 FT

(57) ABSTRACT

It is provided an electrically powered fish tape manipulating device. The device includes a control unit, a power source and a two-way belt system rotatable in accordance with the provided power. A segment of the fish tape is disposed forcibly on the belt such that rotating the belt system forces the fish tape to propagate accordingly. The device includes a rotatable reel assembly for receiving a length of a fish tape. Manipulation parameters include direction and speed of belt rotation, and a serial list of manipulations, defined by direction, speed and duration values. A motor receives the provided power, a gear reduces rotation speed, and drives the two-way rotating belt system. A sliding clutch having a sliding surface forces the fish tape segment to propagate whenever the belt rotates. The control unit is associated with a wireless remote controller. A conduit coupler receives the fish tape and guides it into a conduit. The coupler includes a guiding pipe for guiding the fish tape between the device and the conduit, a fastening member, and means for pressing portions of the fastening member to walls of a structure associated with the conduit, thereby connecting the guiding pipe to the conduit.

### BACKGROUND OF THE INVENTION

1. Field of the Invention

The invention is in the field of accessories for electricity and communications technicians. It deals especially with an automatic device for pushing and pulling a fish tape.

2. Description of Related Art

Building codes require electrical and communications wiring to be enclosed within a housing like a conduit or a pipe. Usually, the conduit is installed in the building during construction, sometimes with a drawing rope there within. For installing electrical and communication wiring, in absence of an appropriate drawing rope a fish tape is pushed along the conduit from end to end, the desired wire is coupled to the fish tape on one end, and an operator pulls the fish tape and the coupled wire from the other end.

Manual operation of a fish tape is physically demanding, time consuming and labor intensive, and two workers are usually needed, one at each end of the conduit. Moreover, sometimes a snagging of the fish tape occurs, causing a lot of unplanned workload. Thus, an electrically powered automatic device for facilitating the pushing and pulling of a fish tape may save a lot of hard work and the need for two workers.

### BRIEF SUMMARY OF THE INVENTION

It is provided according to preferred embodiments of the current invention an electrically powered fish tape manipulating device. The device includes a control unit for determining manipulation parameters, a power source for providing power in accordance with the determined parameters, and a two-way belt system rotatable in accordance with the provided power. A segment of the fish tape is disposed forcibly on the belt such that rotating the belt system forcing the fish tape to propagate accordingly.

Preferably, the device further includes a rotatable reel assembly for receiving a length of a fish tape. Exemplary manipulation parameters include direction and speed of belt rotation, and a serial list of manipulations, whereas each manipulation is defined by a direction value, a speed value and a duration value.

Preferably, a motor receives the provided power, a gear is associated with the motor for reducing rotation speed, which gear drives the two-way rotating belt system.

In some embodiments, a sliding clutch forces the fish tape segment to propagate whenever the belt rotates. Preferably, the sliding clutch includes a sliding surface or several freely rotatable rollers.

In some embodiments, the device includes an interface for fastening the device to a conduit coupler.

In some embodiments, the control unit is associated with an operator interface having a display for presenting an operating state of the device, and a length parameter defining state of the fish tape.

In some embodiments, the control unit is associated with a wireless remote controller for controlling the device from a remote location.

It is provided according to preferred embodiments of the current invention a method for manipulating a fish tape. The method includes disposing a segment of a fish tape forcibly on a belt of a two-way belt system such that rotating the belt system forces the fish tape to propagate accordingly, determining manipulation parameters, and rotating the belt system in accordance with the determined manipulation parameters. Preferably, the method further includes a step of positioning a length of the fish tape in a rotatable reel assembly such that manipulating the fish tape causes wrapping the fish tape on the reel assembly or releasing the fish tape from the reel assembly. Preferably, the method includes a step of forcing the segment onto the belt using a sliding clutch.

In some embodiments, the method includes a step of directing the fish tape into a conduit using a conduit coupler. Preferably, the method includes a step of monitoring length of a fish tape residing in a conduit.

In some embodiments, the method includes a step of wirelessly controlling manipulating of the fish tape.

In some embodiments, the method includes a step of presenting on a display an operating state of a device containing the two-way belt system, a length parameter which defines state of the fish tape, and a snagging state of the fish tape.

In some embodiments, the method includes a step of detecting a snagging state of the fish tape, a step of stopping manipulating of the fish tape upon the detecting, and a step of applying a snagging releasing mode.

In some embodiments, the method includes a step of switching empowering state in accordance with an applicable power source.

It is provided according to preferred embodiments of the current invention a conduit coupler for receiving a fish tape from a fish tape manipulating device and for guiding the fish tape into a conduit. The coupler includes a guiding pipe for receiving the fish tape from the fish tape manipulating device, an embracing member connected to the guiding pipe, and a coupling mechanism for fastening the embracing member to the conduit.

In some embodiments, the coupler includes several arms pivotably extending from a first ring circling the guiding pipe, which is displaceable towards and away from the embracing member. The two or more arms are forced to lean on a second ring, whereas the second ring is longitudinally fixed relative to the embracing member. Displacing the first ring towards the embracing member causes the arms to expand outwardly within the structure and to press walls such as to fasten the embracing member to the conduit.

In some embodiments, the coupler includes a conic hollow portion connected to the embracing member and externally threaded for intense friction within a conduit. Rotating the conic hollow portion causes the portion to propagate into the conduit and to press the conduit wall such as to fasten the embracing member to the conduit.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1 is a front view of a fish tape manipulating device.

FIG. 2 is an electrical block diagram of the fish tape manipulating device.

FIG. 3a depicts the fish tape manipulating device with exposed belt and clutch systems.

FIG. 3b is a sectional view of the belt and clutch systems.

FIG. 3c depicts the reel assembly, the belt system and the clutch system.

FIG. 4 is a back view of the fish tape manipulating device.

FIG. 5 is a flow chart of a method for manipulating a fish tape.

FIG. 6a is a perspective view of a four arm conduit coupler.

FIG. 6b is a sectional view of the four arm conduit coupler.

FIG. 7a shows a second embodiment of a four arm conduit coupler.

FIG. 7b shows the arms pressing wall of a structure holding the conduit.

FIG. 8a depicts a conic conduit coupler.

FIG. 8b shows the conic conduit coupler within a conduit held by housing.

FIG. 8c is a sectional view of the conic conduit coupler, the housing and the conduit.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

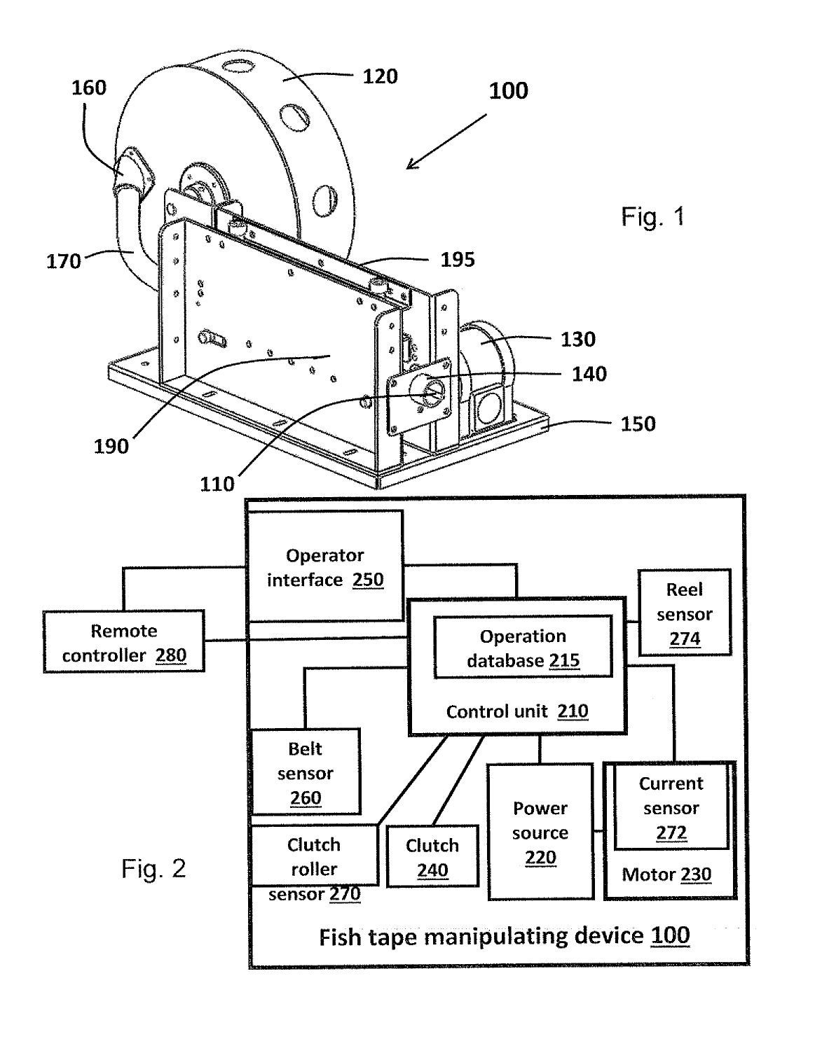

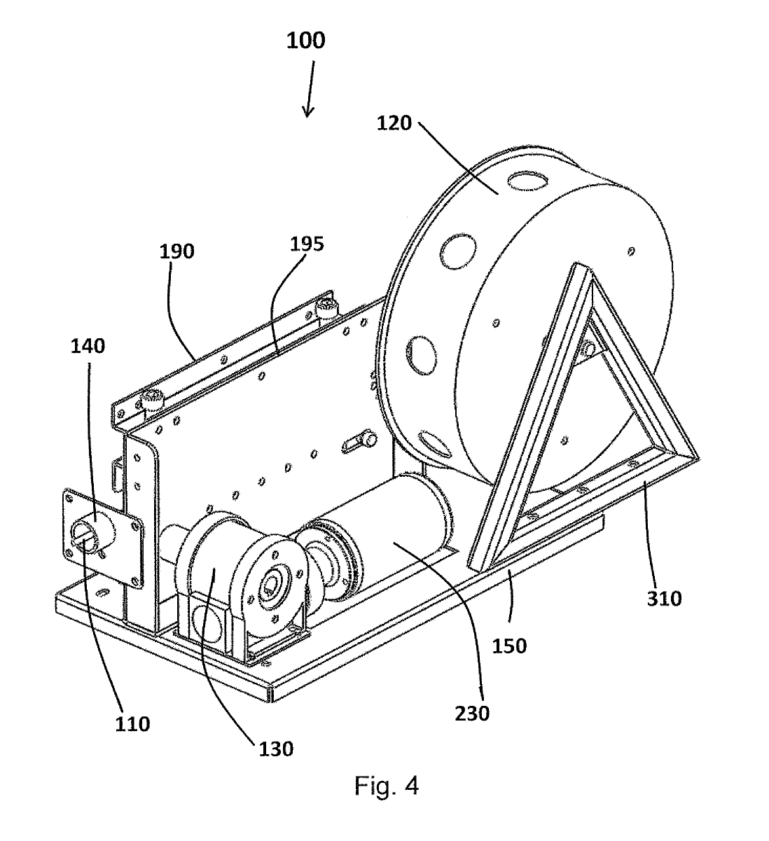

### A Fish Tape Manipulating Device (FIGS. 1-4)

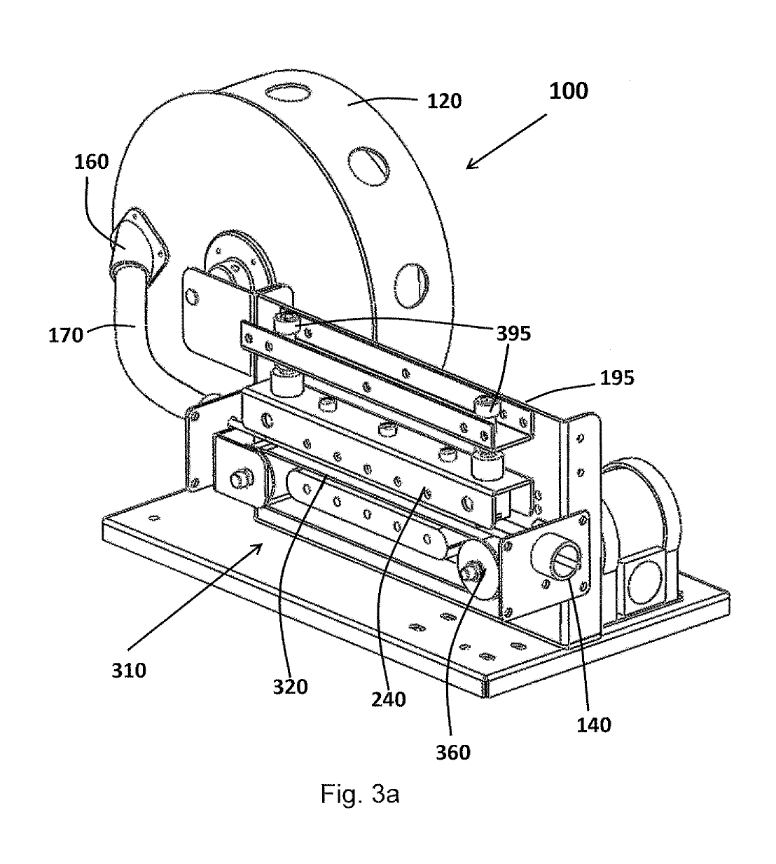

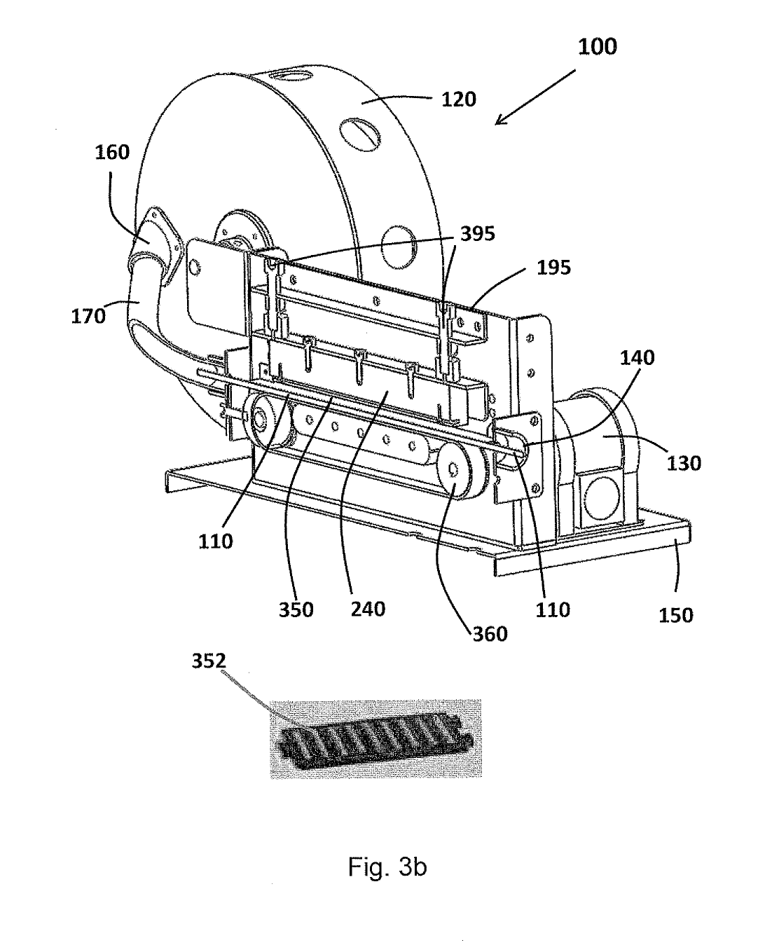

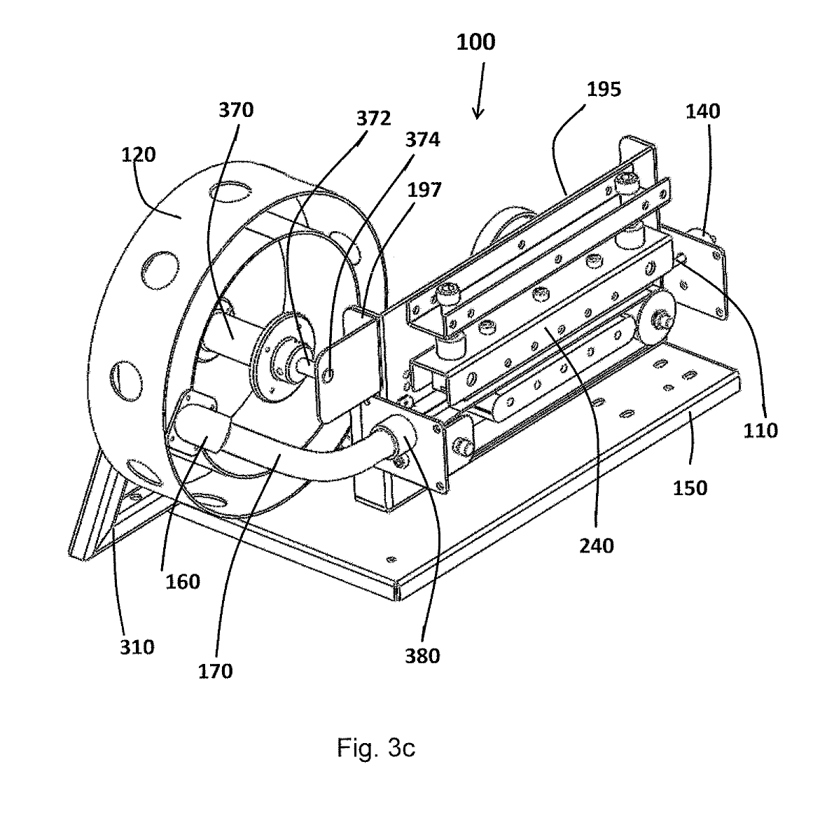

A powered fish tape manipulating device 100 is presented in FIG. 1, FIG. 2, FIG. 3a, and FIG. 3b. Device 100 includes a computerized control unit 210 for determining manipulation parameters, a power source 220 for providing power in accordance with the determined parameters, and a two-way belt system 310 rotatable in accordance with the provided power. A segment 110 of the fish tape is disposed forcibly on belt 320 such that rotating the belt system 310 forcing the fish tape to propagate accordingly.

A rotatable reel assembly 120 receives a length of a fish tape (not shown). The reel is free to rotate in response to pulling the fish tape from the reel assembly or pushing the fish tape into the reel system. A knee coupler 160 guides the fish tape smoothly as it exits from the reel assembly to a guiding pipe 170 or as it is drawn from pipe 170 into reel assembly 120.

Exemplary manipulation parameters are direction and speed of belt rotation. Also, the control unit stores in an operation database 215 several serial lists of manipulations, whereas each manipulation is defined by a direction value, a speed value and a duration value. A manipulation parameter may be a pointer to a specific serial list of manipulation. In a case of snagging, for example, the control unit 210 determines a specific list of manipulations especially appropriate for the type of snagging that has occurred. The type of snagging, in turn, is found by analysis of signals received from sensors 260 and 270 monitoring the fish tape propagation, current sensor 272 which monitors high motor currents typical to snagging, or reel sensor 274.

For snagging release, motor 230 may apply a series of short pulling pulses, a series of short pushing series, or a series of alternating pulling and pushing pulses, as dictated by a corresponding list of manipulations issued by control unit 210. Actually, a vibration in a certain frequency is caused by such a series of pulses.

A motor 230 receives the provided power from power source 220, and drives an associated gear system 130 which reduces rotation speed, and in turn drives belt system 310.

Referring now to FIGS. 2,3a, and 3b, a sliding clutch 240, also controlled by control unit 210, presses fish tape segment 110 such that there is enough friction between belt 320 and fish tape segment 110 to enforce segment 110 to propagate whenever belt 320 rotates. For that arm, sliding clutch 240 includes a sliding surface 350 made of a material like Teflon, Polyethylene, or polished stainless steel that has such a smooth surface that there is much less friction between fish tape 110 and sliding surface 350, comparing to the friction between segment 110 and belt 320. Consequently, whenever belt 320 rotates, segment 110 propagates accordingly, while sliding relative to surface 350.

Belt 320 and segment 110 have preferably an effective touching length of at least 200 mm, wherein effective touching length is the length over which clutch 240 presses segment 110 to belt 320. Preferably, the width of belt 320 is at least 20 mm.

Belt 320 pulls or pushes fish tape segment 110 by a force which equals the product of the normal force applied by clutch 240 on segment 110 times a friction coefficient between belt 320 and segment 110. Typically, the friction coefficient is at least 0.3.

Belt 320 may be made of polyurethane layer strengthened by Kevlar® Preferably, a second polyurethane layer may be used to provide more strength and/or friction.

Alternatively, a plurality of freely rotatable linear bearings 352 may press segment 110 transversely to belt 320 such that tape segment 110 has sufficient friction with belt 320 while allowing it to rotate the freely rotating bearings.

Two screws 395 are used to push clutch 240 down to belt 320. Screws 395 may be rotated by small motors and controlled by control unit 210.

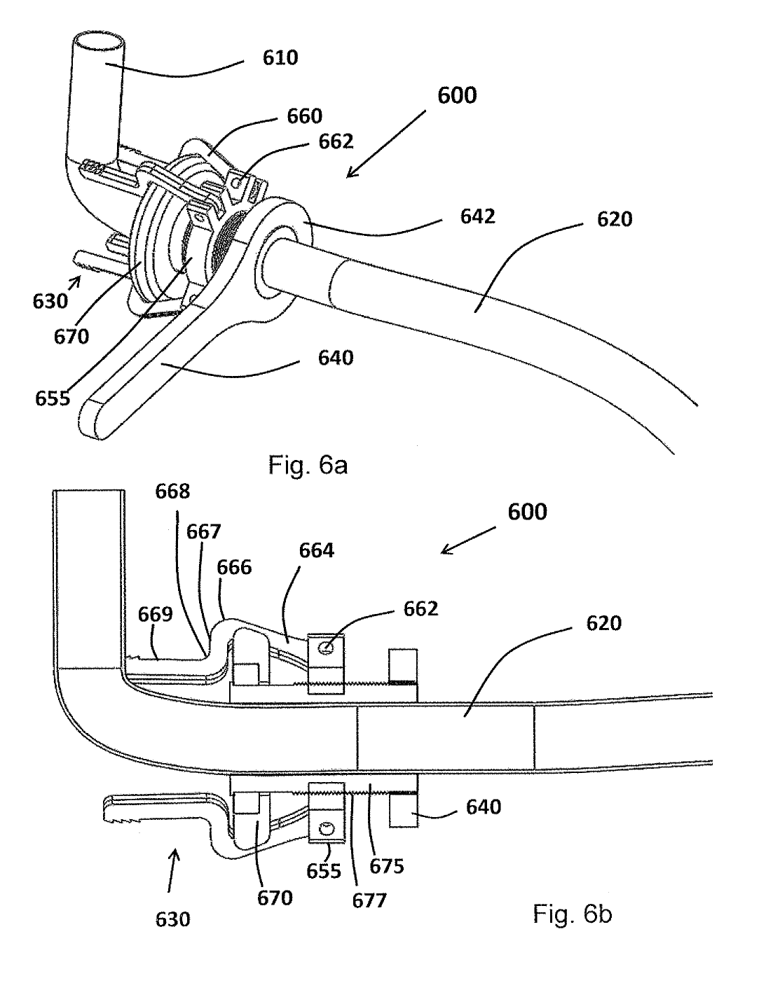

An interface 140 fastens the device to a conduit coupler (shown in FIGS. 6-8).

Control unit 210 is linked to an operator display interface 250 such that an operator controls device 100 through interface 250. Interface 250 also presents an operating state of device 100. Exemplary device state is “pulling, speed-0.5 m per minute”. Another device state example is “stopped due to snagging”. Interface 250 may also presents a length parameter defining state of the fish tape, such as the length residing outside device 100 or within a conduit.

The length of fish tape exiting the device may be monitored using a variety of sensors. For example, a belt sensor 260 traces the rotation of pulley 360 of the belt system, and feeds rotation measurements to control unit 210, which in turn integrates the measurements, deduces the fish tape length residing outside device 100 and stores that length in database 215. The length is used immediately in case of snagging to estimate the snagging location, and may be used later for analysis of the performance of device 100.

Operation database 215 may be used to register all operations conducted by device 100, and thus to provide statistical data on device 100. In a possible business model, device 100 is acquired by an equipment rental store, which charges a renting technician a fixed daily sum plus a variable sum proportional to the number of operations or the length pushed and drawn by device 100.

In the case that clutch 240 includes freely rotatable rollers, a clutch roller sensor 270 is used to count roller revolutions at each direction. The length of the fish tape residing outside the device is easily calculated from the revolutions count. That length may be compared to a length deduced from measurements taken by belt sensor 260. Ideally, the two length estimations should be the same, and thus a significant deviation between the two estimations may be used to check device performance and ensure that it is not broken.

For operating device 100 from the other side of a wall or a building, without the help of additional technician or operator, device 100 is equipped with a wireless remote controller 280. Remote control 280 may be linked to control unit 210 directly or linked to it indirectly via operator display interface 250. Data displayable on the operator interface 250 may also appear on a display of remote control 280, including direction and speed of tape propagation, and length residing outside device 100.

Device 100 is installed on a base 150, which may be made heavy enough such that in addition to the other parts of device 100, the device stays in place while the fish tape is pulled to or pushed from a conduit. Guiding the fish tape between device 100 and the conduit is further discussed below in reference to FIGS. 6-8.

Frames 190 and 195 cover belt system 310 and clutch 240 from two opposite sides, such as to protect operator's hands and fingers from moving parts of device 100. A triangular reel support 310 is forged to base 150 and supports a reel system 120. A reel support member 197 is coupled to frame 195 and has an hole 374 for receiving an axis 372 of reel 370. Another end of axis 372 is supported by reel support 310.

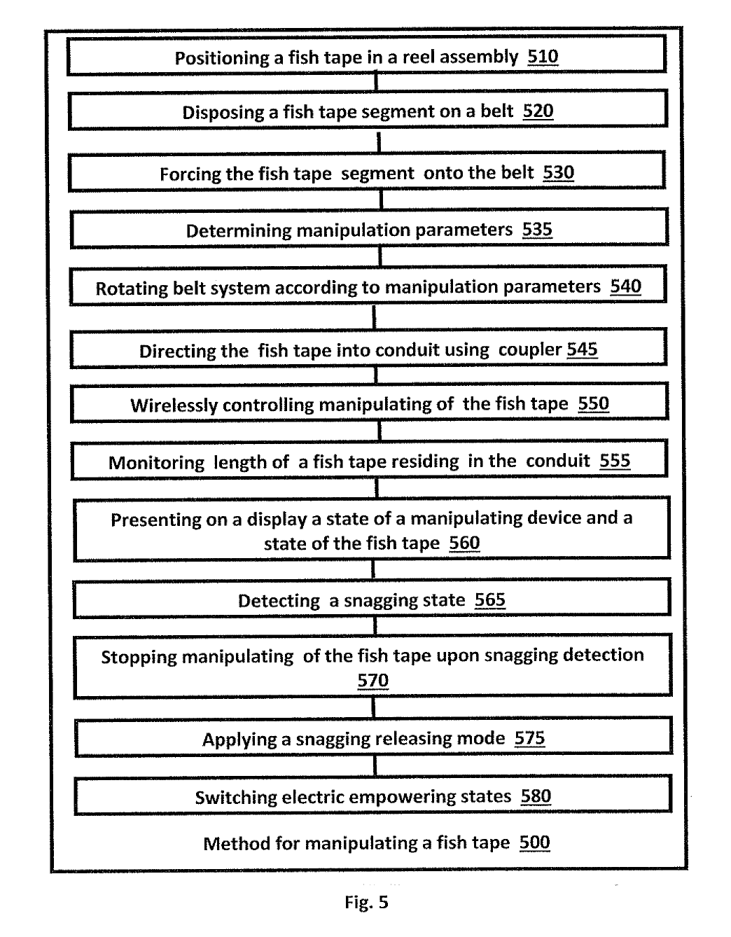

### A Method for Manipulating a Fish Tape (FIG. 5)

It is provided a method 500 for manipulating a fish tape, as shown in FIG. 5. The steps of method 500 may be performed in any order or simultaneously, unless it is clear from the context that one step depends on another being performed first.

Method 500 includes a step 510 of positioning a length of the fish tape in a rotatable reel assembly 120 such that manipulating the fish tape causes wrapping the fish tape on or releasing the fish tape from reel assembly 120. Method 500 also includes a step 520 of disposing a segment 110 of the fish tape on a belt 520 of a two-way belt system 510 and a step 530 of forcing segment 110 onto belt 520 using a sliding clutch 240. Consequently, rotating belt system 510 forces fish tape segment 110 to propagate accordingly. Method 500 further includes a step 535 of determining manipulation parameters, and a step 540 of rotating the belt system in accordance with the determined manipulation parameters.

Preferably, method 500 also includes a step 545 of directing the fish tape into a conduit using a conduit coupler (shown in FIGS. 6-8). Preferably, method 500 includes a step 545 of wirelessly controlling manipulating of the fish tape using remote controller 280.

Method 500 also includes a step 555 of monitoring length of the fish tape residing outside device 100. The operator may feed the device with the length of a guiding pipe between device 100 and the entrance to the conduit, and device 100 gets the length of the fish tape within the conduit by subtraction. Method 500 further includes a step 560 of presenting on a display the obtained length as well as operating state of device 100, and a snagging state of the fish tape in case that snagging has occurred.

Preferably, method 500 includes a step 565 of detecting a snagging state of the fish tape, a step 570 of stopping manipulating of the fish tape upon detecting a snagging state, and a step 575 of applying a snagging releasing mode. The releasing mode is implemented by a serial list of manipulations, as elaborated in reference to FIGS. 1-4.

Device 100 may be operated from either a rechargeable battery or directly from a mains electric supply, if available. As the operating mode may be affected by the type of power source used, device 100 may have respective empowering states. Thus, method 500 includes a step 580 of switching empowering state in accordance with an applicable power source.

### A Conduit Coupler (FIGS. 6-8)

Referring now to FIGS. 6a, 6b, 7 and 8, there are provided several embodiments 600,700 and 800 of a conduit coupler for receiving a fish tape from a fish tape manipulating device 100 and for guiding the fish tape into a conduit 610.

Coupler 600 includes a guiding pipe 620, fastening arms 630 and means 640 for pressing parts 668 of fastening arms 630 to walls of a structure (not shown) associated with conduit 610, thereby connecting guiding pipe 620 to conduit 610. Interface 140 of FIG. 1 fastens guiding pipe 620 to device 100.

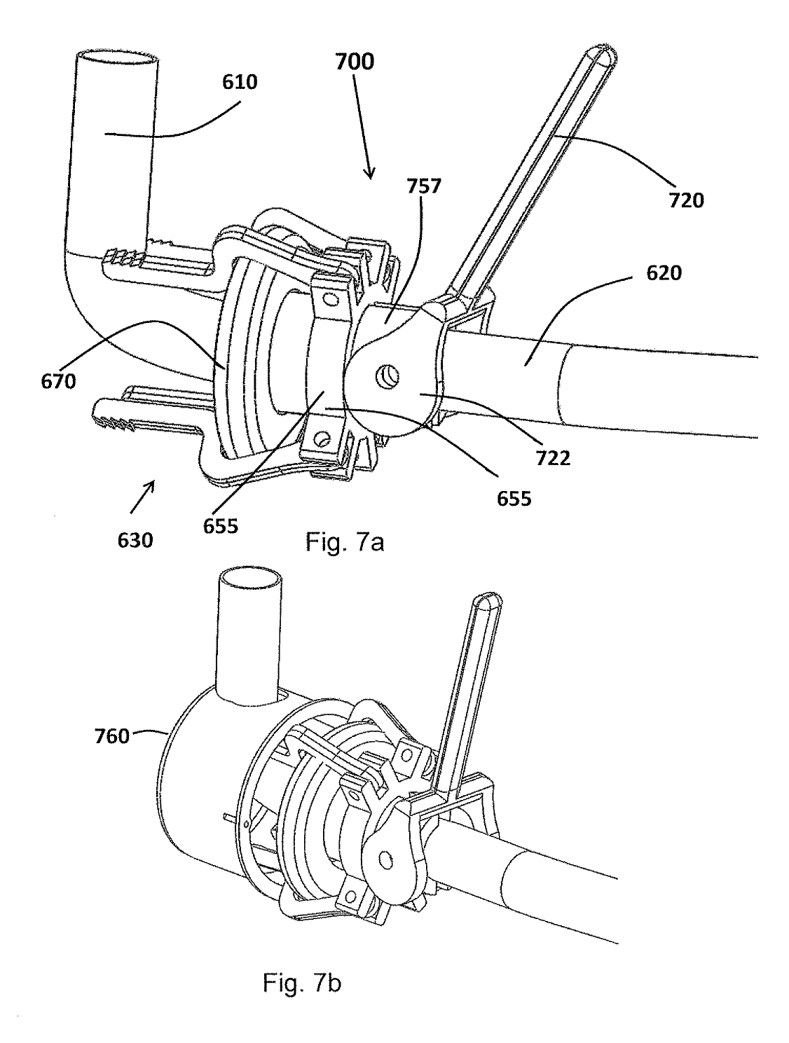

Coupler 600 integrates two mechanisms to obtain coupling of a guiding pipe 620 to conduit 610. The first mechanism converts a rotational motion to a longitudinal motion, while the second mechanism converts the longitudinal motion to a transversal motion. For the first mechanism, an embracing member, tube 657 slidably embraces guiding pipe 620 and has an external thread 677 by which a ring 655 having a respective thread is screwed. An handle 640 has a ring portion 642 fixedly connected to tube 675. Rotating handle 640 around guiding pipe 620 and within ring 655, which is kept from rotation, causes longitudinal displacement of tube 675 relative to ring 655. Initially, ring 655 is kept from rotating by a grasping hand. Once arms 630 press on walls of structure 760 (see FIG. 7b) there is no need of a grasping hand and the rotation strengthens the coupling of the arms to structure 760.

For the second mechanism of converting a longitudinal motion to a transversal motion, fastening arm 630 pivotably extends from axis 662 which in turn is attached to a ring 655. Arm 630 has a linear portion 664 sloping outwardly from axis 662 and ending at a knee 666, a linear portion 667 extending inwardly from knee 666 and ending at a knee 668, and a linear portion 669 extending longitudinally from knee 668. Linear portion 664 leans on a ring 670 which is fixed to tube 657. As ring 670 moves away from conduit 610, linear portions 664 climb on ring 670 and linear portion 669 moves transversely and outwardly within the structure, such as press walls of structure 760 (shown in FIG. 7b) and fasten guiding pipe 620 to conduit 610.

In the embodiment of FIGS. 7a and 7b, a coupler 700 is depicted, whereas the rotation of the first mechanism is conducted in a plane perpendicular to the rotation plane of FIG. 6. For that sake, it is provided an handle 720 which has a pear shaped portion 722 mounted pivotably on a tube 757 such that pear shaped portion 722 slides on ring 655, while tube 757 embraces conduit 620 slidably. As handle 720 is deflected pivotally, the distance between ring 655 and ring 670 changes in accordance with the pear shape of portion 722.

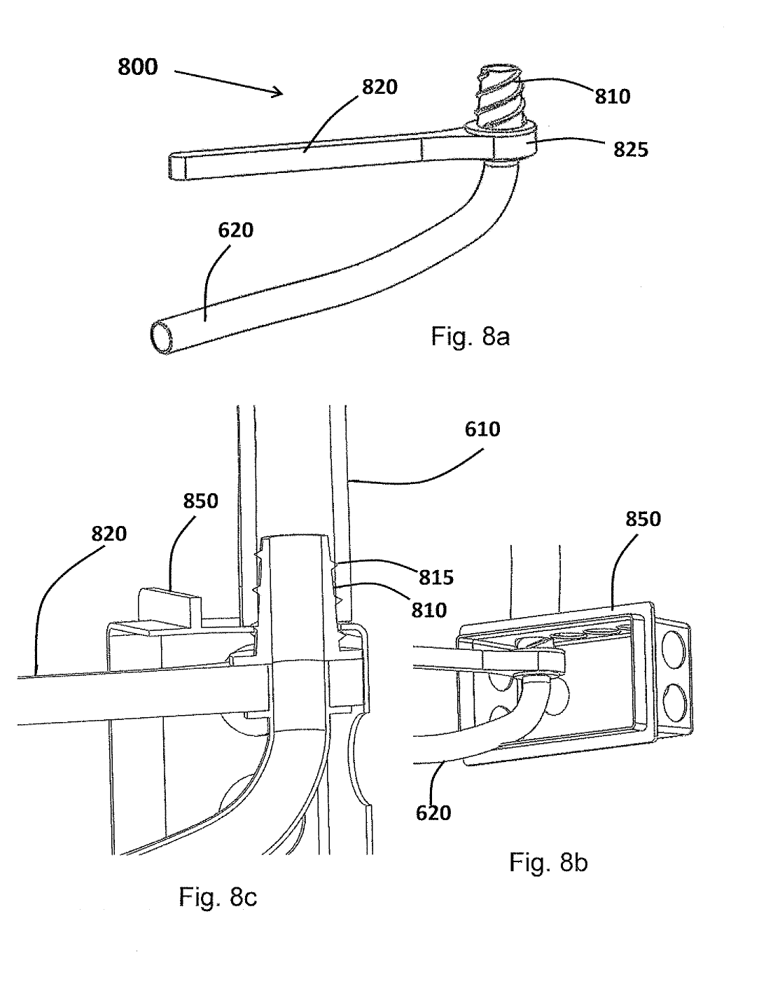

A conic coupler 800 is depicted in FIGS. 8a. 8b and 8c. Coupler 800 is coupled to guiding pipe 620 such that it is free to rotate around it. Coupler 800 includes an handle 820, an embracing ring 825 which is connected to handle 820 and embraces pipe 620 slidably, and a conic hollow portion 810 having an external thread 815. Portion 810 is forced into conduit 610 emitted out of structure 850, and rotating handle 820 causes portion 810 to propagate into conduit 610 while strengthening coupling between coupler 800 and pipe 610. conduit wall transversely such as to fasten guiding pipe 620 to conduit 610.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. An electrically powered fish tape manipulating device associated with a power source, the device comprising:
(a) a control unit for:
(i) determining two or more manipulation parameters; and
(ii) driving the power source to provide power in accordance with the determined parameters;
(b) a two-way belt system rotatable in accordance with the provided power; and
(c) a segment of said fish tape being disposed forcibly on the belt such that rotating said belt system forcing said fish tape to propagate accordingly.

2. The device of claim 1 wherein the power source is a mains power source or a rechargeable battery.

3. The device of claim 1 wherein the device further includes a rotatable reel assembly for receiving a length of a fish tape.

4. The device of claim 1, wherein said two or more manipulation parameters include at least one parameter of the group of parameters consisting of:
(i) direction of belt rotation;
(ii) speed of belt rotation; and
(iii) a pointer to a serial list of manipulation steps, each manipulation step is defined by a direction value, a speed value and a duration value.

5. The device of claim 1, wherein the device includes a motor for receiving the provided power, and a gear associated with said motor for reducing rotation speed, whereby said gear drives said two-way rotating belt system.

6. The device of claim 1, wherein the device includes a sliding clutch for forcing said segment to propagate whenever said belt rotates by friction with said belt, while said segment sliding relative to said sliding clutch.

7. The device of claim 6, wherein said sliding clutch includes a sliding surface or a plurality of freely rotatable rollers.

8. The device of claim 1, wherein the device includes an interface for fastening the device to a conduit coupler.

9. The device of claim 1, wherein the control unit is associated with a wireless remote controller for controlling the device from a remote location.

10. The device of claim 1, wherein the control unit is associated with at least one operator interface, said operator interface has a display for presenting at least one state of the group of states consisting of:
(i) an operating state of the device; and
(ii) a length parameter defining state of said fish tape.

11. The device of claim 1, wherein said belt and said segment have an effective touching length of at least 200 mm, wherein effective touching length is the length over which said segment is disposed forcibly on said belt.

12. The device of claim 1, wherein the width of said belt is at least 20 mm.

13. The device of claim 1, wherein the friction coefficient between said belt and said segment is at least 0.3.

14. A method for manipulating a fish tape, the method comprising:
(a) disposing a segment of a fish tape forcibly on a belt of a two-way belt system such that rotating the belt system forcing said fish tape to propagate accordingly;
(b) determining two or more manipulation parameters; and
(c) rotating said two-way rotating belt system in accordance with the determined manipulation parameters,
thereby forcing said fish tape to propagate accordingly.

15. The method of claim 14 wherein the method further includes a step of positioning a length of said fish tape in a rotatable reel assembly such that manipulating said fish tape causing wrapping said fish tape on said reel assembly or releasing said fish tape from said reel assembly.

16. The method of claim 14, wherein the method includes a step of forcing said segment onto said belt using a sliding clutch.

17. The method of claim 14, wherein the method includes a step of directing said fish tape into a conduit using a conduit coupler.

18. The method of claim 14, wherein the method includes a step of wirelessly controlling manipulating of said fish tape.

19. The method of claim 14, wherein the method includes a step of monitoring length of a fish tape residing in a conduit.

20. The method of claim 14, wherein the method further includes a step of presenting on a display at least one state of the group of states consisting of:
(i) an operating state of a device containing said two-way belt system;
(ii) a length parameter defining state of said fish tape; and
(ii) a snagging state of said fish tape.

21. The method of claim 14, wherein the method includes a step of detecting a snagging state of said fish tape and a step of stopping manipulating of said fish tape upon said detecting.

22. The method of claim 14, wherein the method includes a step of applying a snagging releasing mode.

23. The method of claim 14, wherein the method includes a step of switching empowering state in accordance with an applicable power source.

24. The method of claim 14, wherein the maximal speed of fish tape propagation is at least 20 meter per minute.

25. The method of claim 24, wherein the maximal speed of fish tape propagation is at least 30 meter per minute.

26. A conduit coupler for receiving a fish tape from a fish tape manipulating device and for guiding the fish tape into a conduit, the coupler comprising:
(a) a guiding pipe for receiving the fish tape from the fish tape manipulating device;
(b) an embracing member connected to said guiding pipe; and
(c) a coupling mechanism for fastening said embracing member to the conduit.

27. The conduit coupler of claim 26 wherein the coupler comprises:
(i) two or more arms pivotably extending from a first ring circling said guiding pipe;
(ii) said first ring is displaceable towards and away from said embracing member;
(iii) said two or more arms are forced to lean on a second ring; and
(iv) said second ring is longitudinally fixed relative to the embracing member, whereby displacing the first ring towards said embracing member causes the arms to expand outwardly within said structure and to press walls such as to fasten the guiding pipe to the conduit.

28. The conduit coupler of claim 26 wherein the coupler includes a conic hollow portion connected to said embracing member and externally threaded for intense friction within a conduit, such that rotating said conic hollow portion causes the portion to propagate into said conduit and to press the conduit wall such as to fasten the guiding pipe to the conduit.
